(19) United States
(12) Patent Application Publication
(10) Pub. No.: US 2008/0240714 A1
(43) Pub. Date: Oct. 2, 2008

(54) STATION TERMINATING DEVICE, SUBSCRIBER TERMINATING DEVICE, COMMUNICATION SYSTEM, CONTROL METHOD OF THE DEVICES, AND RECORDING MEDIUM RECORDED WITH PROGRAM

(76) Inventor: Yoshinori Tsukahara, Tokyo (JP)

Correspondence Address: NEC CORPORATION OF AMERICA, 6535 N. STATE HWY 161, IRVING, TX, 75039, US

(21) Appl. No.: 12/048,080

(22) Filed: Mar. 13, 2008

(30) Foreign Application Priority Data
Mar. 26, 2007 (JP) 2007-079105

(51) Int. Cl. H04B 10/08

(52) U.S. Cl. 398/22

(57) ABSTRACT

To shorten the service downtime as a communication system and to provide improved performance in communication by only checking if a device, in which the continuation of communication has become impossible, has recovered, a station terminating device includes: a connection management unit for maintaining without stopping a bandwidth allocation to a connected subscriber terminating device even when receiving a communication inability message from the subscriber terminating device; and a signal existence detection unit for detecting existence of a signal from the subscriber terminating device after receiving the communication inability message from the subscriber terminating device.

This application is based upon and claims the benefit of priority from Japanese patent application No. 2007-079105, filed on Mar. 26, 2007, the disclosure of which is incorporated herein in its entirety by reference.

### BACKGROUND OF THE INVENTION

1. Field of the Invention

The present invention relates to a station terminating device, a subscriber terminating device, a communication system, a control method of the devices, and a recording medium recorded with a program, in which the subscriber terminating device is connected to the station terminating device in a system such as a PON (Passive Optical Network), and in which the station terminating device is used so as to manage the connection of the subscriber terminating device.

2. Description of Related Art

In general, there is a communication system constructed by connecting an OLT (Optical Line Termination; station optical network terminating device) and a subscriber optical network terminating device (hereinafter referred to as ONU) called an ONU (Optical Network Unit) or an ONT (Optical Network Termination).

A process by such a communication system in a related art of the present invention will be described with reference to FIGS. 1 and 2.

As shown in FIGS. 1 and 2, after receiving a Dying Gasp message (power failure message) from an ONU (b), an OLT in a related art halts and checks the bandwidth allocation (service) to an ONU (a) upon periodical (for every predetermined time) detection and restarting process of the ONU (b). This process is periodically repeated until the OLT detects the ONU (b) and completes restarting of the ONU (b). Three repetitions are illustrated as an example in FIG. 1.

In a distance measurement method previously filed by the present applicant, whether activation is caused by the initial connection operation from the ONU power-on or caused by restarting after the ONU in an operation state has fallen into an abnormal state is determined before starting the distance measurement process. When the activation is determined to be by restarting, the previous delay measurement value in the operation state is established as a delay reference value (for example, see Japanese Patent Laid Open Publication No. 2002-359629).

Problems of the ONU detection by the related arts described above will now be described.

A first problem is that the connection information required for communication that has been used by the OLT and the ONU is discarded after receiving the Dying Gasp message. Therefore, upon checking for the restarting process, the OLT cannot check only if the ONU has recovered.

A second problem is that the system has to detect and execute the restarting process from the initial stage, because the system cannot check only if the ONU has recovered due to the first problem. Therefore, the process cannot be taken not to affect the services to other ONUs. In other words, the checking process periodically continues to oppress the services to other ONUs until the ONU to be restarted is detected.

Furthermore, the technique described in Japanese Patent Laid Open Publication No. 2002-359629 is intended to reduce the occupation of the bandwidth by a distance measurement window, and is not intended to take into consideration not to affect the services to other ONUs by the OLT only checking if the ONU, in which the continuation of communication has become impossible, has recovered.

### SUMMARY OF THE INVENTION

The present invention has been made to solve the above problems. An exemplary object of the present invention is to provide a station terminating device, a subscriber terminating device, a communication system, a control method of the devices, and a recording medium recorded with a program that can shorten service downtime as a communication system and that can provide improved performance in communication by only checking if a device, in which the continuation of communication has become impossible, has recovered.

In order to accomplish the exemplary object, a station terminating device of the present invention includes: a connection management part that maintains without stopping a bandwidth allocation to a connected subscriber terminating device even when receiving a communication inability message from the subscriber terminating device; and a signal existence detection part that detects existence of a signal from the subscriber terminating device after receiving the communication inability message from the subscriber terminating device.

A subscriber terminating device of the present invention includes: a communication inability detection part that detects a fact that continuation of communication will be impossible immediately before the continuation of communication becomes impossible; and a connection information holding part that holds connection information that has been used for communication with the station terminating device even after the inability to continue communication is detected by the communication inability detection part.

A communication system of the present invention is configured by connecting the station terminating device of the present invention and a plurality of the subscriber terminating devices of the present invention through a connection branched part.

A control method of the station terminating device according to the present invention includes: a connection management step of maintaining without stopping a bandwidth allocation to a connected subscriber terminating device when receiving a communication inability message from the subscriber terminating device; and a signal existence detection step of periodically detecting existence of a signal from the subscriber terminating device at the same time as the connection management step.

A control method of the subscriber terminating device according to the present invention includes: a communication inability detection step of detecting a fact that continuation of communication will be impossible immediately before the continuation of communication becomes impossible; and a connection information holding step of holding connection information that has been used for communication with the station terminating device even after the inability to continue communication is detected by the communication inability detection step.

A recording medium recorded with a control program of the station terminating device according to the present invention causes a computer to execute: a connection management process for maintaining without stopping a bandwidth allocation to a connected subscriber terminating device when receiving a communication inability message from the subscriber terminating device; and a signal existence detection process for periodically detecting existence of a signal from the subscriber terminating device at the same time as the connection management process.

A recording medium recorded with a control program of the subscriber terminating device according to the present invention causes a computer to execute: a communication inability detection process for detecting a fact that continuation of communication will be impossible immediately before the continuation of communication becomes impossible; and a connection information holding process for holding connection information that has been used for communication with the station terminating device even after the inability to continue communication is detected by the communication inability detection process.

### BRIEF DESCRIPTION OF THE DRAWINGS

The exemplary objects and features of the present invention will become more apparent from the consideration of the following detailed description taken in conjunction with the accompanying drawings, in which:

FIG. 1 is a sequence diagram of an ONU restarting process in a communication system of a related art;

FIG. 2 is a timing diagram of an operation example of bandwidth allocation in an OLT of the related art;

FIG. 3 is a block diagram of a configuration example of a G-PON system as an exemplary embodiment of the present invention;

FIG. 4 is a block diagram of an outline of main parts of an OLT 1 in the system;

FIG. 5 is a block diagram of an outline of main parts of an ONU 4 in the system;

FIG. 6 is a sequence diagram of an ONU restarting process in the system; and

FIG. 7 is a timing diagram of an operation example of bandwidth allocation in the OLT 1 according to the present exemplary embodiment.

### DESCRIPTION OF EXEMPLARY EMBODIMENTS

One exemplary embodiment in which a station terminating device, a subscriber terminating device, a communication system, a control method of the devices, and a recording medium recorded with a program of the present invention are applied to a G-PON (based on a PON system in compliance with ITU-T 984 series standard) system will now be described in detail with reference to the drawings.

An outline of the present exemplary embodiment will be described first.

The present exemplary embodiment is characterized in that, in the operation of the G-PON system, downtime of the services of other ONUs is reduced upon restarting of an ONU installed in a user's (service user) home when a power shutdown occurs to the ONU.

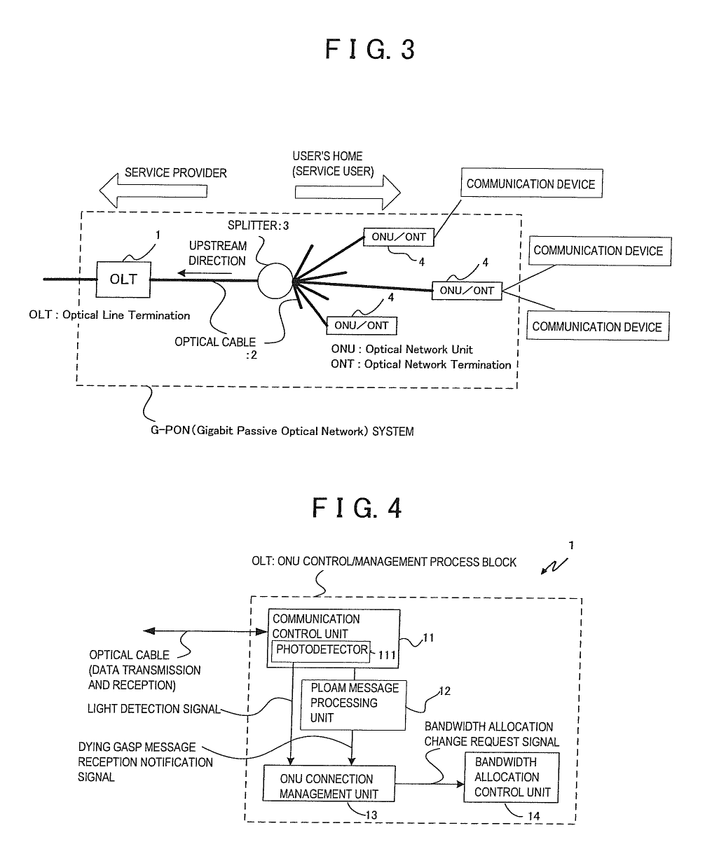

As shown in FIG. 3, in the G-PON system of the present exemplary embodiment, an OLT (station terminating device) 1 operated by a service provider and ONUs (subscriber terminating devices) 4 used by users (service users) are connected via optical cables (transmission paths) 2 and a splitter (connection branched part) 3. The G-PON system is installed at a substantially specific position (substantially fixed place). It is assumed that the ONU 4 is installed in an environment where the connection distance to the OLT 1 or the connection environment does not change even if a user moves the ONU 4.

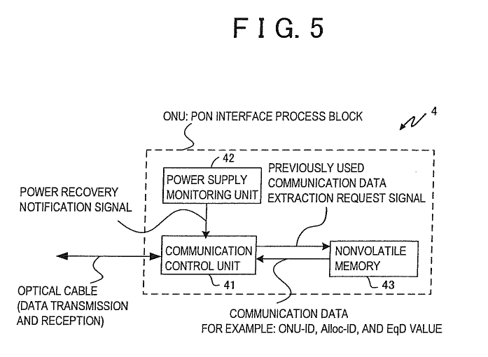

As shown in FIG. 4, an ONU connection management unit (connection management unit) 13 in the OLT 1 transmits a change request signal of the bandwidth allocation to a bandwidth allocation control unit 14 when receiving, from a PLOAM (Physical Layer Operations, Administration, and Management) message processing unit 12, a reception notification signal of a Dying Gasp message indicating that an ONU 4 has detected a power failure. In this case, instead of halting the bandwidth allocation to the ONU 4, the bandwidth allocation is narrowed down such that the bandwidth allocation provides the smallest possible (minimum) bandwidth that the ONU connection management unit 13 can receive a signal from the ONU 4.

As shown in FIG. 4, when receiving a signal from the ONU 4, a photodetector 111 of a communication control unit 11 transmits a light detection signal to the ONU connection management unit 13. This signal is used for the purpose of confirming the existence of the ONU 4.

After receiving the Dying Gasp message, the ONU connection management unit 13 (signal existence detection unit) checks only the light detection signal from the photodetector 111.

As shown in FIG. 5, a communication control unit (communication control unit and message transmitter) 41 in the ONU 4 communicates with the OLT 1 while causing a power supply monitoring unit (communication inability detection unit) 42 to monitor the condition of the power and stores communication data (such as EqD value, ONU-ID, and Alloc-ID) for communicating and connecting with the OLT 1 in a nonvolatile memory (connection information holding unit) 43 as connection information.

When receiving a power recovery notification signal from the power supply monitoring unit 42, the communication control unit 41 extracts data (connection information used in the previous connection) necessary for resuming communication with the OLT 1 from the nonvolatile memory 43 and uses the data as initial data for resuming communication. In this case, the communication control unit 41 is characterized in that the connection information used in the communication with the previous OLT 1 is not discarded but is used as data for resuming communication.

Thus, in the present exemplary embodiment, when the OLT 1 receives a Dying Gasp message, the bandwidth allocation is maintained without cutting off the connection even after the communication of the ONU 4 that has transmitted the massage has actually become impossible. And, when the ONU 4 recovers communication, the previous values that have been held are used for resuming the communication. Therefore, the ONU 4 can immediately respond to the communication connection request from the OLT 1.

Whether the ONU 4 is normally activated and has recovered communication needs to be first checked during an unspecified time before communication between the ONU 4 is resumed. In this checking process too, the optical detection function of the ONU is used to check the existence of the ONU 4, allowing subsequent recovering with almost no influence on the services to other ONUs.

Thus, in the G-PON system of the present exemplary embodiment, there is an advantage that the parameter for adjusting the propagation time of data (EqD value) barely changes because the installed positions of the OLT 1 and the ONUs 4 barely change. Taking the advantage, instead of halting the services in order to detect the ONU 4, the smallest possible bandwidth allocation is periodically conducted even after receiving a Dying Gasp message from an ONU 4. Upon the power recovery, the ONU 4 responds to the bandwidth allocation from the OLT 1 using the communication data, such as an EqD value that has been used in the previous connection, as connection information without change.

In an initial stage for recovering the ONU 4 to the original state, the object is to detect whether the ONU 4 has recovered when the ONU connection management unit 13 of the OLT 1 is in standby. Therefore, only a signal from the ONU 4 in relation to the bandwidth allocation needs to be detected, and after the detection, the ONU 4 executes a restarting process in compliance with the standard. By separating and realizing the detection and the restarting process of the ONU 4 in this way, the OLT 1 can execute the recovery process of the ONU 4 with almost no influence on the services to other ONUs 4 even if the time of the recovery of the ONU 4 is unspecified.

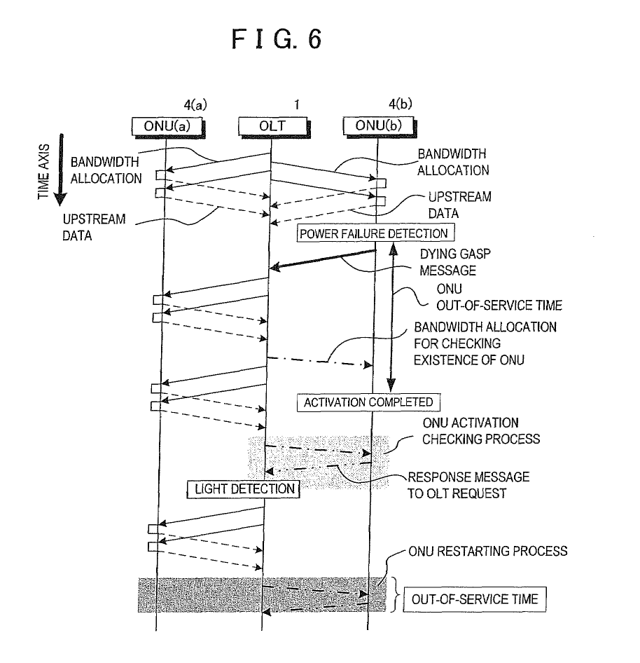

FIG. 6 illustrates a process flow from halt to restart of the ONU 4 in the G-PON system of the present exemplary embodiment. As shown in FIG. 6, the OLT 1 calculates and allocates proper bandwidths to all connected ONUs 4 (ONU 4(a) and ONU 4(b) in FIG. 6) and controls the flow rate of the upstream data of the ONUs.

Although the services of the ONU 4(b) is stopped after the OLT 1 has received a Dying Gasp message from the ONU 4(b), the OLT 1 periodically continues a minimum amount of bandwidth allocation in which the bandwidth is narrower than before the reception of the Dying Gasp message. When the problem of the power or the like is solved and the activation is completed, the ONU 4(b) makes a response in accordance with the bandwidth allocated from the OLT 1 using the previously (before the transmission of the Dying Gasp message) used values.

When receiving a signal from the ONU 4(b), the ONU connection management unit 13 of the OLT 1 determines that the ONU 4(b) can be recovered to the original state and then restarts the ONU 4(b).

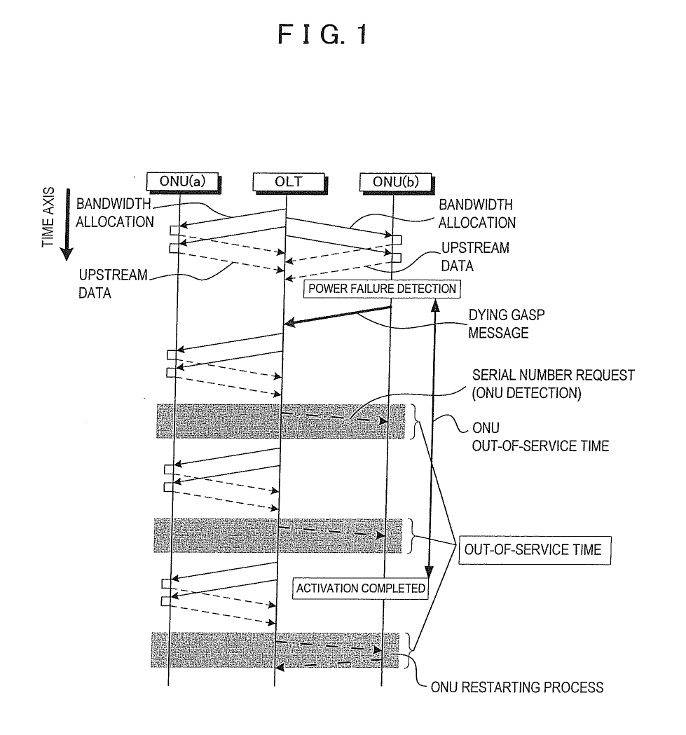

The operation of the system in a related art of the present invention is illustrated in FIG. 1, and differences from the process flow of the present exemplary embodiment shown in FIG. 6 will now be described.

As shown in FIG. 1, after receiving the Dying Gasp message from the ONU (b), the OLT periodically halts the services of the ONU (a) from the stage of the ONU detection before restarting the ONU (b) and then checks the ONU (b).

The OLT continues to halt the services to the ONU (a) because how much time is required from the shift of the ONU (b) to the out-of-service state to the completion of restarting is unknown.

Unlike the operation of the system of the related art shown in FIG. 1, in the operation of the present exemplary embodiment shown in FIG. 6, after receiving a Dying Gasp message from the ONU 4(b), the OLT 1 continues only the smallest possible bandwidth allocation that enables to check the existence of the reception of an optical signal on the purpose of checking the completion of the activation of the ONU 4(b). Therefore, the ONU 4(b) can be recovered with almost no influence on the services to the ONU 4(a).

Although the present exemplary embodiment has been described in detail, the restarting process of the ONU in compliance with the standard is well known to those skilled in the art and is not directly related to the present invention. Therefore, the detailed description of the restarting process will be omitted.

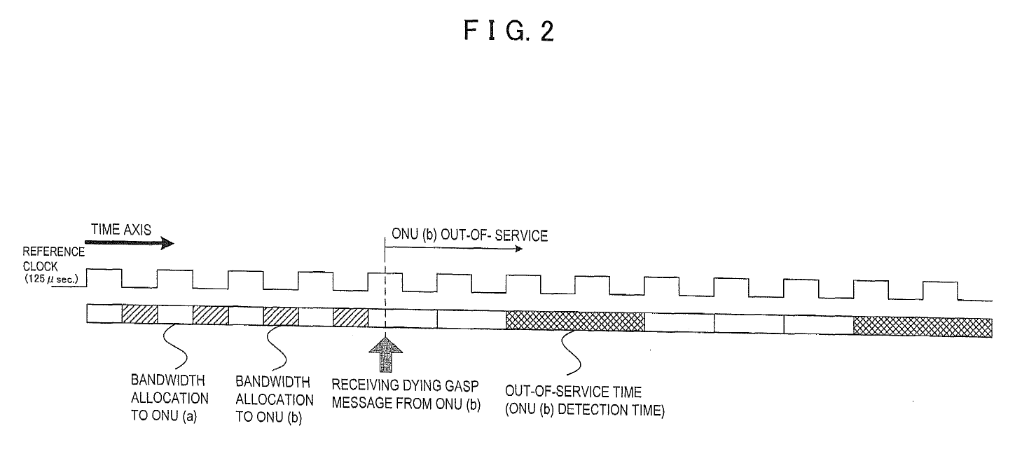

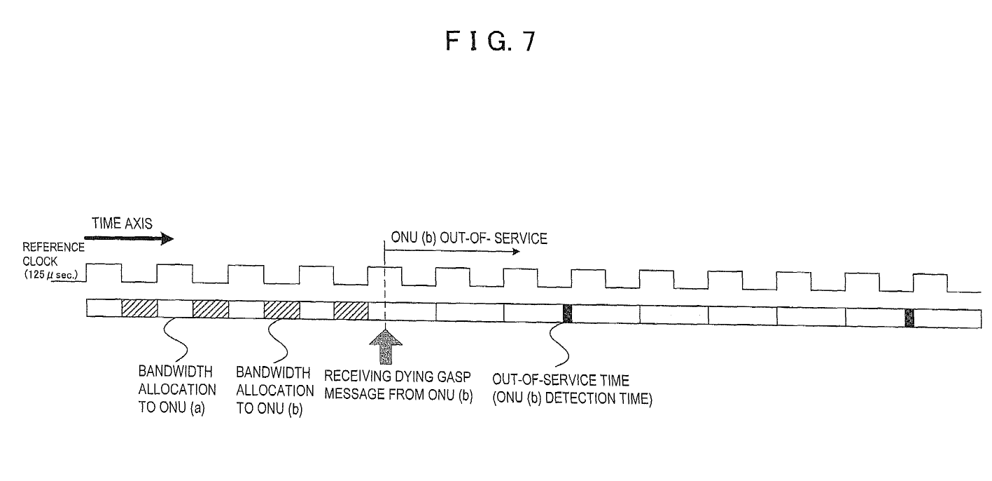

The operation of the process of the bandwidth allocation according to the present exemplary embodiment described above using FIG. 6 will now be described with reference to a time chart in FIG. 7 by comparing with a time chart of FIG. 2 which illustrates the operation by the related art of the present invention.

As shown in FIG. 7, the OLT 1 of the present exemplary embodiment allocates bandwidths to the ONU 4(a) and ONU 4(b) on an as needed basis and controls the flow rate of the upstream data from each ONU. As shown In FIG. 7, when the OLT 1 receives a Dying Gasp message from the ONU 4(b), the service to the ONU 4(b) is stopped from that point, and in this case, the bandwidth allocation to the ONU 4(a) is basically continued. The smallest possible bandwidth allocation to the ONU 4(b) is periodically performed to redetect the ONU 4(b).

If the connection distance between the OLT and the ONU is assumed to be 20 km, the periodical service downtime is about 250 microseconds in the operation of the system of the related art shown in FIG. 2, while the same process can be accomplished with the service downtime of about several microseconds to several tens of microseconds in the present exemplary embodiment as shown in the time chart of FIG. 7.

When compared under the same environment, the process in the related art shown in FIG. 2 requires about 250 microseconds of out-of-service time because the OLT detects and restarts the ONU from the beginning. The OLT has to periodically execute the restarting process because when the ONU will recover its communication is not known. Therefore, the services to other ONUs are unnecessarily stopped, and the time may continue to be wasted.

On the other hand, according to the exemplary embodiment of the present invention, the OLT only checks if the ONU in which the continuation of communication has become impossible has recovered, thereby enabling not to affect the services to other ONUs. As a result, upon managing the connection to a plurality of ONUs by one interface of the OLT, the mutual interference can be reduced as much as possible while providing added value and improved performance.

As described above, the present exemplary embodiment provides following advantages.

A first advantage is that the communication can be checked even after the restart of the ONU is completed because the previous connection information and the connection condition are maintained even after the generation and reception of the Dying Gasp message.

A second advantage is that the existence of the ONU can be checked in a remarkably short time since the OLT 1 includes the photodetector 111.

A third advantage is that the ONU 4 which has transmitted the Dying Gasp message can be recovered with almost no influence on other ONUs as a result of the first and second advantages.

The exemplary embodiments described above are preferred exemplary embodiments of the present invention which is not limited to these exemplary embodiments, and the exemplary embodiments may be variously embodied and practiced based on the technical concept of the present invention.

For example, various processing units described in the exemplary embodiments above may be implemented as hardware or software.

The ONU redetection method in the G-PON system as an exemplary embodiment described above can be applied to time-division multiplexing communication systems in general.

The functions of the exemplary embodiments of the present invention can be accomplished by recording, as a program, the procedure for realizing the G-PON system of the exemplary embodiments described above in a recording medium and then causing the CPU of a computer that comprises the system to execute the functions by the program supplied from the recording medium. In this case, the present invention can also be applied when supplying the information including the program from the recording medium or from an external recording medium through a network to an output device.

More specifically, the program codes read out from the recording medium will realize new functions of the present invention, and the recording medium storing the program codes and the signals read out from the recording medium will comprise the present invention.

Examples of the recording medium include a flexible disk, a hard disk, an optical disk, a magnetic optical disk, a CD-ROM, a CD-R, a CD-RW, a DVD-ROM, a DVD-RAM, a DVD-RW, a DVD+RW, a magnetic tape, a nonvolatile memory card, and a ROM.

The recording medium recorded with the program of the present invention can cause a computer controlled by the program to realize the functions of the G-PON system of the exemplary embodiments of the present invention described above.

As can been seen, a station terminating device of the present invention includes: a connection management unit for maintaining without stopping a bandwidth allocation to a connected subscriber terminating device even when receiving a communication inability message from the subscriber terminating device; and a signal existence detection unit for detecting existence of a signal from the subscriber terminating device after receiving the communication inability message from the subscriber terminating device.

When receiving the communication inability message from the subscriber terminating device, the connection management unit preferably maintains the bandwidth allocation to the subscriber terminating device, the bandwidth narrower than before receiving the communication inability message.

When receiving the communication inability message from the subscriber terminating device, the connection management unit preferably maintains the bandwidth allocation to the subscriber terminating device, the bandwidth narrowed down to the minimum bandwidth that allows detection by the signal existence detection unit.

The communication inability message is preferably a power failure message from the subscriber terminating device.

A subscriber terminating device of the present invention includes: a communication inability detection unit for detecting a fact that the continuation of communication will be impossible immediately before the continuation of communication becomes impossible; and a connection information holding unit for holding connection information that has been used for communication with the station terminating device even after the inability to continue communication is detected by the communication inability detection unit.

The subscriber terminating device preferably includes a communication control unit for resuming communication using connection information, as initial data, held in the connection information holding unit when communication has again become possible after the communication inability detection unit has detected the fact that the communication is about to be discontinued and the continuation of communication has become impossible.

The subscriber terminating device preferably includes a message transmitting unit for transmitting a communication inability message to the station terminating device when the communication inability detection unit detects the fact that the communication is about to be discontinued.

Preferably, the communication inability detection unit is configured so as to detect the fact that the continuation of communication will be impossible due to power failure immediately before the discontinuation, and the communication inability message transmitted by the message transmitting unit is a power failure message.

A communication system of the present invention is configured by connecting a station terminating device of the present invention and a plurality of subscriber terminating devices of the present invention through a connection branched unit.

A control method of the station terminating device according to the present invention includes: a connection management step of maintaining without stopping a bandwidth allocation to a connected subscriber terminating device when receiving a communication inability message from the subscriber terminating device; and a signal existence detection step of periodically detecting existence of a signal from the subscriber terminating device at the same time as the connection management step.

When receiving the communication inability message from the subscriber terminating device, the connection management step preferably maintains the bandwidth allocation to the subscriber terminating device, the bandwidth narrower than before receiving the communication inability message.

When receiving the communication inability message from the subscriber terminating device, the connection management step preferably maintains the bandwidth allocation to the subscriber terminating device, the bandwidth narrowed down to the minimum bandwidth that allows detection by the signal existence detection step.

The communication inability message is preferably a power failure message from the subscriber terminating device.

A control method of the subscriber terminating device according to the present invention includes: a communication inability detection step of detecting a fact that continuation of communication will be impossible immediately before the continuation of communication becomes impossible; and a connection information holding step of holding connection information that has been used for communication with the station terminating device even after the inability to continue communication is detected by the communication inability detection step.

The control method preferably includes a communication control step of resuming communication using connection information, as initial data, held in the connection information holding step when communication has again become possible after the communication inability detection step has detected the fact that the communication is about to be discontinued and the continuation of communication has become impossible.

The control method preferably includes, before the communication control step, a message transmitting step of transmitting a communication inability message to the station terminating device when the communication inability detection step detects the fact that the communication is about to be discontinued.

Preferably, the communication inability detection step detects the fact that the continuation of communication will be impossible due to power failure immediately before the discontinuation, and the communication inability message transmitted by the message transmitting step is a power failure message.

A control program of the station terminating device according to the present invention causes a computer to execute: a connection management process for maintaining without stopping a bandwidth allocation to a connected subscriber terminating device when receiving a communication inability message from the subscriber terminating device; and a signal existence detection process for periodically detecting existence of a signal from the subscriber terminating device at the same time as the connection management process.

When receiving the communication inability message from the subscriber terminating device, the connection management process preferably maintains the bandwidth allocation to the subscriber terminating device, the bandwidth narrower than before receiving the communication inability message.

When receiving the communication inability message from the subscriber terminating device, the connection management process preferably maintains the bandwidth allocation to the subscriber terminating device, the bandwidth narrowed down to the minimum bandwidth that allows detection by the signal existence detection process.

The communication inability message is preferably a power failure message from the subscriber terminating device.

A control program of the subscriber terminating device according to the present invention causes a computer to execute: a communication inability detection process for detecting a fact that continuation of communication will be impossible immediately before the continuation of communication becomes impossible; and a connection information holding process for holding connection information that has been used for communication with the station terminating device even after the inability to continue communication is detected by the communication inability detection process.

The control program preferably further causes a computer to execute a communication control process for resuming communication using connection information, as initial data, held in the connection information holding process when communication has again become possible after the communication inability detection process has detected the fact that the communication is about to be discontinued and the continuation of communication has become impossible.

The control program preferably causes a computer to execute, before the communication control process, a message transmitting process for transmitting a communication inability message to the station terminating device when the communication inability detection process detects the fact that the communication is about to be discontinued.

Preferably, the communication inability detection process detects the fact that the continuation of communication will be impossible due to power failure immediately before the discontinuation, and the communication inability message transmitted by the message transmitting process is a power failure message.

As described, according to the present invention, the service downtime as a communication system can be shortened and improved performance in communication can be provided by only checking if a device, in which the continuation of communication has become impossible, has recovered.

What is claimed is:

1. A station terminating device including:
a connection management part that maintains without stopping a bandwidth allocation to a connected subscriber terminating device even when receiving a communication inability message from the subscriber terminating device; and
a signal existence detection part that detects existence of a signal from the subscriber terminating device after receiving the communication inability message from the subscriber terminating device.

2. The station terminating device according to claim 1, wherein
when receiving the communication inability message from the subscriber terminating device, the connection management part maintains the bandwidth allocation to the subscriber terminating device, the bandwidth narrower than before receiving the communication inability message.

3. The station terminating device according to claim 1, wherein
when receiving the communication inability message from the subscriber terminating device, the connection management part maintains the bandwidth allocation to the subscriber terminating device, the bandwidth narrowed down to the minimum bandwidth that allows detection by the signal existence detection part.

4. The station terminating device according to claim 1, wherein the communication inability message is a power failure message from the subscriber terminating device.

5. A station terminating device including:
a connection management unit for maintaining without stopping a bandwidth allocation to a connected subscriber terminating device even when receiving a communication inability message from the subscriber terminating device; and
a signal existence detection unit for detecting existence of a signal from the subscriber terminating device after receiving the communication inability message from the subscriber terminating device.

6. A subscriber terminating device including:
a communication inability detection part that detects a fact that the continuation of communication will be impossible immediately before the continuation of communication becomes impossible; and
a connection information holding part that holds connection information that has been used for communication with the station terminating device even after the inability to continue communication is detected by the communication inability detection part.

7. The subscriber terminating device according to claim 6, further including a communication control part that resumes communication using connection information, as initial data, held in the connection information holding part when communication has again become possible after the communication inability detection part has detected the fact that the communication is about to be discontinued and the continuation of communication has become impossible.

8. The subscriber terminating device according to claim 6, further including a message transmitting part that transmits a communication inability message to the station terminating device when the communication inability detection unit detects the fact that the communication is about to be discontinued.

9. The subscriber terminating device according to claim 8, wherein
the communication inability detection part is configured so as to detect the fact that the continuation of communication will be impossible due to power failure immediately before the discontinuation, and
the communication inability message transmitted by the message transmitting part is a power failure message.

10. A subscriber terminating device including:
a communication inability detection unit for detecting a fact that the continuation of communication will be impossible immediately before the continuation of communication becomes impossible; and
a connection information holding unit for holding connection information that has been used for communication with the station terminating device even after the inability to continue communication is detected by the communication inability detection unit.

11. A communication system in which a plurality of subscriber terminating devices including:
a communication inability detection part that detects a fact that the continuation of communication will be impossible immediately before the continuation of communication becomes impossible; and
a connection information holding part that holds connection information that has been used for communication with the station terminating device even after the inability to continue communication is detected by the communication inability detection part
are connected, through a connection branched part, to a station terminating device including:
a connection management part that maintains without stopping a bandwidth allocation to a connected subscriber terminating device even when receiving a communication inability message from the subscriber terminating device; and
a signal existence detection part that detects existence of a signal from the subscriber terminating device after receiving the communication inability message from the subscriber terminating device.

12. A communication system in which a plurality of subscriber terminating devices including:
a communication inability detection unit for detecting the fact that the continuation of communication will be impossible immediately before the continuation of communication becomes impossible; and
a connection information holding unit for holding connection information that has been used for communication with the station terminating device even after the inability to continue communication is detected by the communication inability detection unit
are connected, through connection a branched unit, to a station terminating device including:
a connection management unit for maintaining without stopping a bandwidth allocation to a connected subscriber terminating device even when receiving a communication inability message from the subscriber terminating device; and
a signal existence detection unit for detecting existence of a signal from the subscriber terminating device after receiving the communication inability message from the subscriber terminating device.

13. A control method of a station terminating device including:
a connection management step of maintaining without stopping a bandwidth allocation to a connected subscriber terminating device when receiving a communication inability message from the subscriber terminating device; and
a signal existence detection step of periodically detecting existence of a signal from the subscriber terminating device at the same time as the connection management step.

14. The control method of the station terminating device according to claim 13, wherein
when receiving the communication inability message from the subscriber terminating device, the connection management step maintains the bandwidth allocation to the subscriber terminating device, the bandwidth narrower than before receiving the communication inability message.

15. The control method of the station terminating device according to claim 13, wherein
when receiving the communication inability message from the subscriber terminating device, the connection management step maintains the bandwidth allocation to the subscriber terminating device, the bandwidth narrowed down to the minimum bandwidth that allows detection by the signal existence detection step

16. The control method of the station terminating device according to claim 13, wherein
the communication inability message is a power failure message from the subscriber terminating device.

17. A control method of a subscriber terminating device including:
a communication inability detection step of detecting a fact that the continuation of communication will be impossible immediately before the continuation of communication becomes impossible; and
a connection information holding step of holding connection information that has been used for communication with the station terminating device even after the inability to continue communication is detected by the communication inability detection step.

18. The control method of the subscriber terminating device according to claim 17 further including a communication control step of resuming communication using connection information, as initial data, held in the connection information holding step when communication has again become possible after the communication inability detection process has detected the fact that the communication is about to be discontinued and the continuation of communication has become impossible.

19. The control method of the subscriber terminating device according to claim 18 further including, before the communication control step, a message transmitting step of transmitting a communication inability message to the station terminating device when the communication inability detection step detects the fact that the communication is about to be discontinued.

20. The control method of the subscriber terminating device according to claim 19, wherein
the communication inability detection step detects the fact that the continuation of communication will be impossible due to power failure immediately before the discontinuation, and
the communication inability message transmitted by the message transmitting step is a power failure message.

21. A recording medium recorded with a control program of a station terminating device, the control program causing a computer to execute:
a connection management process for maintaining without stopping a bandwidth allocation to a connected subscriber terminating device when receiving a communication inability message from the subscriber terminating device;
and a signal existence detection process for periodically detecting existence of a signal from the subscriber terminating device at the same time as the connection management process.

22. The recording medium recorded with the control program of the station terminating device according to claim 21, wherein when receiving the communication inability message from the subscriber terminating device, the connection management process maintains the bandwidth allocation to the subscriber terminating device, the bandwidth narrower than before receiving the communication inability message.

23. The recording medium recorded with the control program of the station terminating device according to claim 21, wherein when receiving the communication inability message from the subscriber terminating device, the connection management process maintains the bandwidth allocation to the subscriber terminating device, the bandwidth narrowed down to the minimum bandwidth that allows detection by the signal existence detection process.

24. The recording medium recorded with the control program of the station terminating device according to claim 21, wherein the communication inability message is a power failure message from the subscriber terminating device.

25. A recording medium recorded with a control program of a subscriber terminating device, the control program causing a computer to execute:
a communication inability detection process for detecting a fact that the continuation of communication will be impossible immediately before the continuation of communication becomes impossible; and
a connection information holding process for holding connection information that has been used for communication with the station terminating device even after the inability to continue communication is detected by the communication inability detection process.

26. The recording medium recorded with the control program of the subscriber terminating device according to claim 25, the control program further causing a computer to execute a communication control process for resuming communication using connection information, as initial data, held in the connection information holding process when communication has again become possible after the communication inability detection process has detected the fact that the communication is about to be discontinued and the continuation of communication has become impossible.

27. The recording medium recorded with the control program of the subscriber terminating device according to claim 26, wherein the control program further causes a computer to execute, before the communication control process, a message transmitting process for transmitting a communication inability message to the station terminating device when the communication inability detection process detects the fact that the communication is about to be discontinued.

28. The recording medium recorded with the control program of the subscriber terminating device according to claim 27, wherein
the communication inability detection process detects the fact that the continuation of communication will be impossible due to power failure immediately before the discontinuation, and
the communication inability message transmitted by the message transmitting process is a power failure message.
